(19) United States
(12) Patent Application Publication
(10) Pub. No.: US 2021/0150567 A1
(43) Pub. Date: May 20, 2021

(54) METHODS AND APPARATUS TO DE-DUPLICATE PARTIALLY-TAGGED MEDIA ENTITIES

(71) Applicant: The Nielsen Company (US), LLC, New York, NY (US)

(72) Inventors: Beate Sissenich, New York, NY (US); Abdelaziz Testas, New York, NY (US); Shruthi Koundinya, New York, NY (US); Daniel Odorczyk, New York, NY (US); Peter C. Doe, Ridgewood, NJ (US)

(21) Appl. No.: 17/160,201

(22) Filed: Jan. 27, 2021

Related U.S. Application Data
(63) Continuation of application No. 15/240,865, filed on Aug. 18, 2016.
(60) Provisional application No. 62/206,810, filed on Aug. 18, 2015.

(51) Int. Cl. G06Q 30/02; G06F 16/174

(52) U.S. Cl. CPC G06Q 30/0246; G06F 16/1748

(57) ABSTRACT

Methods, apparatus, systems and articles of manufacture to de-duplicate partially-tagged entities are disclosed. An example method includes identifying a tagged audience for a first sub-entity, identifying a panel audience for the second sub-entity, determining a panel duplication between the first sub-entity and a second sub-entity, determining a duplicated audience based on the tagged audience, the panel audience, and the panel duplication, and determining a de-duplicated audience for the partially-tagged entity based on the duplicated audience and a total audience, the total audience including the tagged audience for the first sub-entity and the panel audience for the second sub-entity.

### RELATED APPLICATIONS

This patent arises from a continuation of U.S. patent application Ser. No. 15/240,865, which was filed on Aug. 18, 2016, which claims the benefit of U.S. Provisional Application Ser. No. 62/206,810, which was filed on Aug. 18, 2015. U.S. patent application Ser. No. 15/240,865 and U.S. Provisional Application Ser. No. 62/206,810 are hereby incorporated herein by reference in their entirety.

### FIELD OF THE DISCLOSURE

This disclosure relates generally to audience measurement and, more particularly, to methods and apparatus to de-duplicate partially-tagged media entities.

### BACKGROUND

In recent years, digital media has been tagged or otherwise embedded with software, scripts, or other programs to report audience measurement information to a media monitoring company. However, not all digital media is tagged. Digital media may be fully-tagged, non-tagged, or partially-tagged (e.g., a combination of tagged and non-tagged).

### BRIEF DESCRIPTION OF THE DRAWINGS

FIG. 1 is a schematic illustration of a hierarchy of example media entities and sub-entities in fully-tagged, partially-tagged, and non-tagged configurations.

FIG. 2 is an illustration of an example environment including a ratings manager to measure one or more audience members.

FIG. 3 is an example implementation of the ratings manager of FIG. 2.

FIGS. 4A-4B are flowcharts representative of example computer-readable instructions to implement the ratings manager of FIGS. 2-3 to process partially-tagged entities.

FIG. 5 is a flowchart representative of example computer-readable instructions to implement the ratings manager of FIGS. 2-3 to process partially-tagged media entities.

FIG. 6 is a flowchart representative of example computer-readable instructions to implement the ratings manager of FIGS. 2-3 to process non-tagged media entities.

FIG. 7 is an example processor platform to execute the example computer-readable instructions of FIGS. 4A-6 to implement the example ratings manager of FIGS. 2-3.

### DETAILED DESCRIPTION

Example methods and apparatus disclosed herein de-duplicate digital audience measurement of partially-tagged media entities. As used herein, entities are collections of one or more instances of media, such as, for example media platforms (e.g., video, application, text, etc.), channels (e.g., a collection of platforms), sub-brands (e.g., a collection of channels), and/or brands (e.g., a collection of sub-brands) representative of a media provider. In some examples, other categorizations may be included such as, for example, assets (e.g., a program series) and/or episodes (e.g., an instance of a program series). In some examples, entities are tagged (e.g., with software, scripts, etc.) to measure and report audience measurements (e.g., unique audience member views) to a media monitoring company with respect to the media provider. Entities may be fully-tagged, non-tagged, or partially-tagged. In some examples, entities include one or more sub-entities. As used herein, sub-entities may also include sub-entities. Sub-entities may be categorized based on a hierarchy, content type (e.g., video, text. etc.), platform type (e.g., mobile, desktop, etc.), or any combination thereof.

In some examples, a media platform is partially-tagged if at least one media of that media platform is fully-tagged, but not all media are fully-tagged. In some examples, a media platform is fully-tagged if an access monitor (e.g., a software development kit (“SDK”)) is implemented on (e.g., incorporated with, embedded in, etc.) a media player, application, or webpage presenting media. As used herein, an access monitor sends impressions of media exposure via the media player, application, or webpage to a media monitoring company (e.g., The Nielsen Company (US), LLC) in response to user action (e.g., loading/selecting a media player, a webpage, an application, an advertisement, etc.).

An impression refers to a recordation of a presentation of an item of media (e.g., from a media campaign) to an audience member. As used herein, the “audience” of a designated item of media refers to the number of persons who have viewed the designated item of media. An “audience member” of an audience refers to an individual person within the audience. Whereas the calculation of the audience of a media item may, in some examples discussed herein, count a single audience member multiple times, the “unique audience” of a media is an audience of the media item in which each audience member is represented only once. “Reach” refers to the amount of a population that corresponds to the measured audience. For example, if the population of an area is 280,000 and the measured audience is 140,000, the reach for a given media campaign is ½ or 50% of the population. “Frequency” refers to the number of times a unique audience member is presented a same media campaign. “Duration” refers to an amount of time that a media is presented and/or viewed.

Media monitoring companies desire knowledge of how users interact with media devices such as smartphones, tablets, laptops, smart televisions, etc. In particular, media monitoring companies want to monitor media presentations made at the media devices to, among other things, monitor exposure to advertisements, determine advertisement effectiveness, determine user behavior, identify purchasing behavior associated with various demographics, etc.

As used herein, “media platforms” are sub-entities of “channels”, “channels” are sub-entities of “sub-brands”, and “sub-brands” are sub-entities of “brands”. As disclosed herein, the status of an entity is dependent on the status of the sub-entities of the entity. Table 1 describes some example entity statuses based on its sub-entities.

TABLE 1

| Sub-Entity 1 | Sub-Entity 2 | Entity Status |
|---|---|---|
| (SE1) | (SE2) | (E1) |
| Non-Tagged | Non-Tagged | Non-Tagged |
| Non-Tagged | Partially-Tagged | Partially-Tagged |
| Non-Tagged | Fully-Tagged | Partially-Tagged |
| Partially-Tagged | Partially-Tagged | Partially-Tagged |
| Partially-Tagged | Fully-Tagged | Partially-Tagged |
| Fully-Tagged | Fully-Tagged | Fully-Tagged |

With reference to Table 1, a channel (e.g., entity) is fully-tagged if all platforms (e.g., sub-entities) under the channel are fully-tagged. In some examples, a sub-brand (e.g., entity) is fully-tagged if all channels (e.g., sub-entities) under the sub-brand are fully-tagged and all platforms under the channels are fully-tagged. In some examples, a brand (e.g., entity) is fully-tagged if all sub-brands (e.g., sub-entities) under the brand are fully-tagged, all channels under the sub-brands are fully-tagged, and all platforms under the channels are fully-tagged. If at least one sub-entity is not fully-tagged, then the entity cannot be fully-tagged. In examples wherein an entity is fully-tagged, tagged data is used in calculating audience metrics.

In some examples, a channel (e.g., entity) is non-tagged if all platforms (e.g., sub-entities) under the channel are non-tagged. In some examples, a sub-brand (e.g., entity) is non-tagged if all channels (e.g., sub-entities) under the sub-brand are non-tagged and all platforms under the channels are non-tagged. In some examples, a brand (e.g., entity) is non-tagged if all sub-brands (e.g., sub-entities) under the brand are non-tagged, all channels under the sub-brands are non-tagged, and all platforms under the channels are non-tagged. If at least one sub-entity is tagged, then the entity cannot be non-tagged. In examples wherein an entity is non-tagged, panelist data is used in calculating audience metrics.

However, in examples wherein an entity is partially-tagged, a combination of panelist data and tagged data is used, as further disclosed herein. As used herein, panelists are users registered on panels maintained by a media monitoring company that owns and/or operates the ratings entity subsystem. Traditionally, media monitoring companies determine demographic reach for advertising and media programming based on registered panel members. That is, a media monitoring company enrolls people that consent to being monitored into a panel. During enrollment, the media monitoring company receives demographic information from the enrolling people so that subsequent correlations may be made between advertisement/media exposure to those panelists and different demographic markets. People become panelists via, for example, a user interface presented on the media device (e.g., via a website). People become panelists in additional or alternative manners such as, for example, via a telephone interview, by completing an online survey, etc. Additionally or alternatively, people may be contacted and/or enlisted using any desired methodology (e.g., random selection, statistical selection, phone solicitations, Internet advertisements, surveys, advertisements in shopping malls, product packaging, etc.).

The methods and apparatus disclosed herein identify a tagged audience for a first sub-entity, identify a panel audience for a second sub-entity, determine a panel duplication between the first sub-entity and the second sub-entity, determine a duplicated unique audience based on the tagged audience, the panel audience, and the panel duplication, and determine a de-duplicated unique audience for the partially-tagged entity based on the duplicated unique audience and a total unique audience, the total unique audience including the tagged audience for the first sub-entity and the panel audience for the second sub-entity. While example methods, apparatus, and articles of manufacture are described herein with reference to sub-entities, it will be appreciated that the descriptions are applicable to entities (e.g., entities may be sub-entities with respect to other entities), as further disclosed herein.

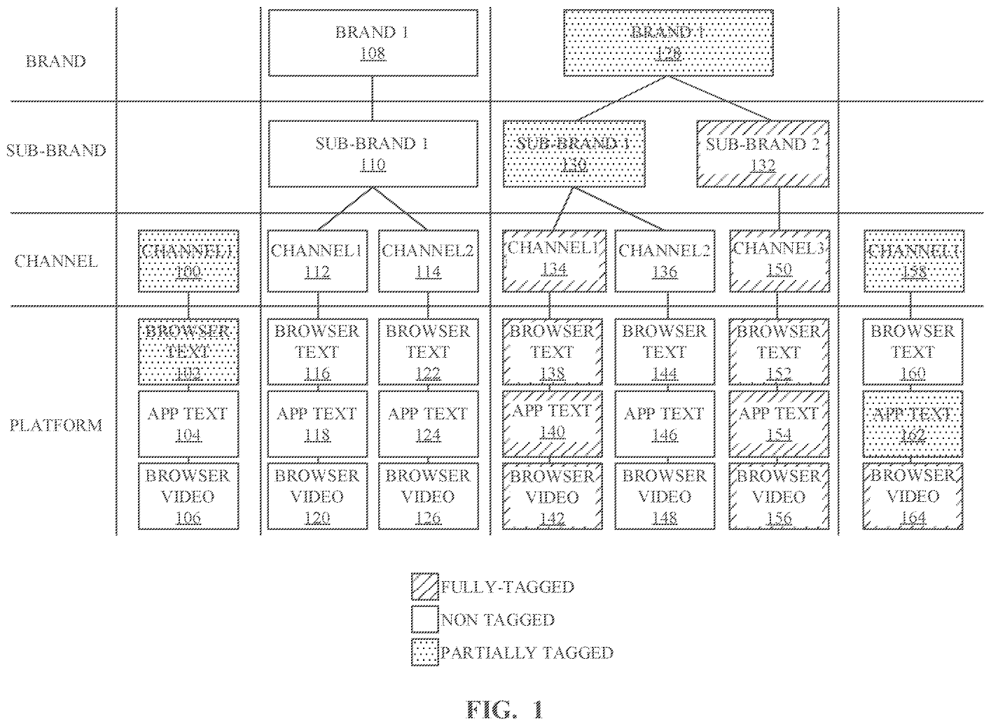

FIG. 1 is a schematic illustration of a hierarchy of example entities and sub-entities in fully-tagged, partially-tagged, and non-tagged configurations. An example implementation of a partially-tagged channel 1 100 includes partially-tagged browser text 102, non-tagged application text 104, and non-tagged browser video 106. In some examples, additional platform categories may be included such as, for example, application video, browser audio, application audio, etc. In such examples, the example methods and apparatus use fusion panelist data for the channel 1 100 because none of the browser text 102, application text 104, or browser video 106 is fully-tagged.

An example implementation of a non-tagged brand 108 includes an example sub-brand 110, which includes an example channel 1 112 and an example channel 2 114. The example channel 1 112 includes example browser text 116, example application text 118, example browser video 120. The example channel 2 114 includes example browser text 122, example application text 124, and example browser video 126. Similar to the partially-tagged channel 1 100, the example methods and apparatus use fusion panelist data for the non-tagged brand 108 because the brand 108 does not include any fully-tagged sub-entities (e.g., the sub-brand 110, the channel 1 112 and corresponding browser text 116, application text 118, browser video 120, the channel 2 114 and corresponding browser text 122, application text 124, browser video 126, etc.).

In examples without at least one fully-tagged entity, a panel of online and mobile panelists (e.g., a fusion panel) is used to determine duplicate unique audience (UA) members between entities or sub-entities (e.g., the number of panelists that view multiple entities or sub-entities). The methods and apparatus disclosed herein remove the duplicate UA members from a total unique audience to determine a de-duplicated unique audience.

An example implementation of a partially-tagged brand 128 includes a partially-tagged sub-brand 1 130 and a fully-tagged sub-brand 2 132. The example partially-tagged sub-brand 1 130 includes an example fully-tagged channel 1 134 and an example non-tagged channel 2 136. The example fully-tagged channel 1 134 includes fully-tagged browser text 138, application text 140, and browser video 142. The example non-tagged channel 1 136 includes non-tagged browser text 144, application text 146, and browser video 148.

The example fully-tagged sub-brand 2 132 includes an example fully-tagged channel 3 150, which includes fully-tagged browser text 152, application text 154, and browser video 156. In such examples, tagged data is used for the fully-tagged sub-brand 2 132 and corresponding channel 3 150, browser text 152, application text 154, and browser video 156. However, as disclosed herein, tagged data is not readily available for the partially-tagged sub-brand 1 130. In examples wherein at least one entity or sub-entity is fully-tagged (but not all), the example methods and apparatus use a combination of fusion panelist data and tagged data to determine the de-duplicated unique audience.

An example implementation of a partially-tagged channel 1 158 includes non-tagged browser text 160, partially-tagged application text 162, and fully-tagged browser video 164. The example channel 1 158 differs from the example channel 1 100 because the example channel 1 158 includes at least one fully-tagged sub-entity (e.g., fully-tagged browser video 164). In some examples, a partially-tagged entity/sub-entity is treated as a non-tagged entity/sub-entity if the entity/sub-entity does not include at least one fully-tagged sub-entity. For example, partially-tagged platforms are treated as non-tagged entities (e.g., partially-tagged platforms do not include at least one fully-tagged entity). In some such examples, partially-tagged channels with no fully-tagged platforms are also treated as non-tagged entities. As disclosed above, the example methods and apparatus use a combination of fusion panelist data and tagged data to determine the de-duplicated unique audience in examples wherein at least one entity or sub-entity, but not all entities or sub-entities, is fully-tagged.

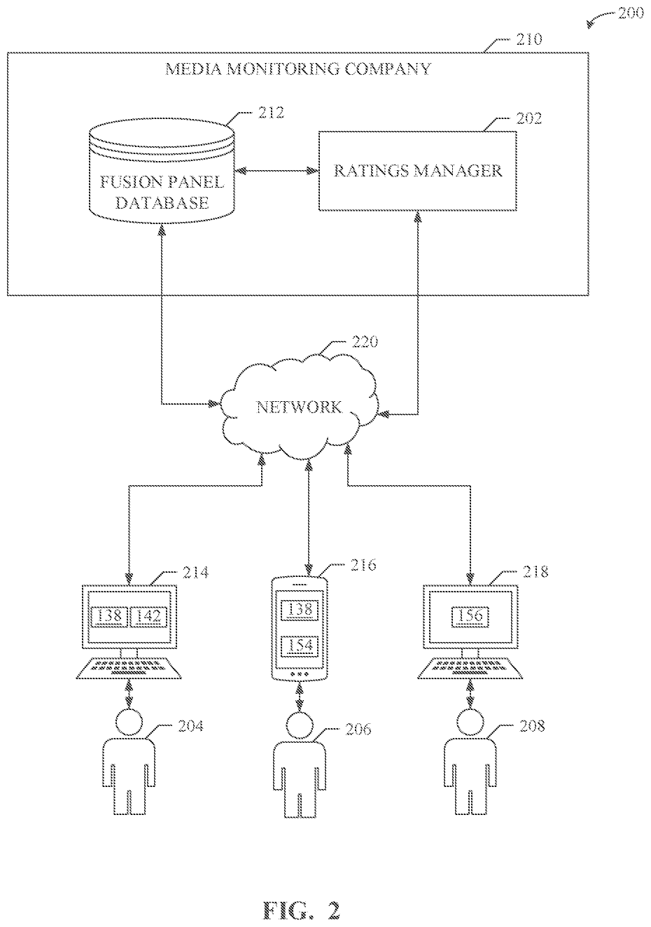

FIG. 2 is an illustration of an example environment 200 including a ratings manager 202 to measure one or more audience members 204, 206, 208. As disclosed herein, the example ratings manager 202 is part of a media monitoring company 210. In some examples, the media monitoring company 210 includes a fusion panel database 212 to provide fusion panelist data for determining de-duplicated unique audiences, as disclosed herein. The example media monitoring company 210 is in communication with one or more computing devices 214, 216, 218 corresponding to the one or more audience members 204, 206, 208 over an example network 220 (e.g., the Internet).

In the illustrated example of FIG. 2, the browser text 138 media platform and the browser video 142 media platform are being presented to a first one of the audience members 204 via a first one of the computing devices 214. The example browser text 138 media platform and the example application text 146 media platform are being presented to a second one of the audience members 206 via a second one of the computing devices 216. The example browser video 156 media platform is being presented to a third one of the audience members 208 via a third one of the computing devices 218.

In some examples, unique audience members are duplicated (e.g., double counted) at the entity level. For example, when the browser text 138 media platform and the browser video 142 media platform (e.g., the sub-entities) are presented to the first one of the audience members 204, the media monitoring company 210 associates one unique audience member for the browser text 138 media platform and one unique audience member for the browser video 142 media platform. In such examples, the media monitoring company 210 associates two unique audience members for the channel 1 134 (e.g., the entity) based on unique audience members of the sub-entities. However, the first one of the audience members 204 is only one unique audience member for the channel 1 134 (e.g., the entity). In some such examples, a count of the unique audience members is de-duplicated.

In some examples, when the browser text 138 media platform (e.g., a sub-entity of channel 1 134) and the application text 154 media platform (e.g., a sub-entity of channel 3 150) are presented to the second one of the audience members 206, the media monitoring company 210 associates one unique audience member for the browser text 138 media platform and one unique audience member for the application text 154 media platform. In such examples, the media monitoring company 210 associates one unique audience member for the channel 1 134 (e.g., a first entity) and associates one unique audience member for the channel 3 150 (e.g., a second entity, because at the channel level, the second one of the audience members 206 is a unique audience member of channel 1 134 and of channel 3 150. In such examples, the channel 1 134 and the channel 3 150 have a correct number of unique audience members.

However, at a higher entity level, the media monitoring company 210 would associate two unique audience members for the brand 1 128 (e.g., the entity) based on the unique audience members of the sub-entities (e.g., one unique audience member for the channel 1 134 and one unique audience member for the channel 3 150). The second one of the audience members 204 is only one unique audience member for the brand 1 128, and the count of the unique audience members is to be de-duplicated. As disclosed herein, the example methods and apparatus de-duplicate the count of unique audience members from sub-entities to entities by determining the number of audience members that view multiple sub-entities of a first entity. The example methods and apparatus roll up an example entity hierarchy (FIG. 1) by determining the number of audience members that view multiple sub-entities of a second entity, wherein the first entity is a sub-entity of the second entity.

Tagged media is often double counted due to the media monitoring company 210 not knowing which unique audience members were presented multiple instances of media. In some examples, the media monitoring company 210 knows which panelists are presented multiple instances of media. However, a panel is limited to those panelists who are enrolled, while tagged media may be distributed to the entire population of a country to acquire audience measurements of the entire population. Accordingly, the example methods and apparatus disclosed herein utilize panelist data in combination with tagged data to determine de-duplicated unique audiences. The example ratings manager 202 utilizes panelist data from the example fusion panel database 212 to de-duplicate partially-tagged entities (e.g., platforms, channels, sub-brands, brands, etc.) accessible by one or more audience members.

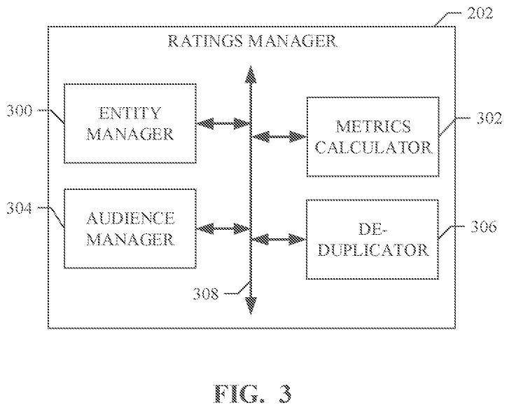

FIG. 3 is an example implementation of the ratings manager 202 of FIG. 2. The example ratings manager 202 includes an entity manager 300, an example metrics calculator 302, an example audience manager 304, and an example de-duplicator 306. In some examples, the entity manager 300, the metrics calculator 302, the audience manager 304, and the de-duplicator 306 are communicatively coupled (e.g., via a bus 308).

The example entity manager 300 determines the status of entities and sub-entities such as, for example, the first media platform 222. As disclosed herein, entities may have a status of fully-tagged, partially-tagged, or non-tagged. In some examples, the entity manager 300 detects whether an entity has an access monitor and/or other audience measurement device that sends media impressions to the media monitoring company 210 to determine whether the entity is fully-tagged. In some examples, the entity manager 300 determines whether all sub-entities are fully-tagged and/or whether all sub-entities are non-tagged. In some such examples, if any sub-entity is not fully-tagged, then the entity manager 300 determines the entity is not fully-tagged. In some such examples, if any sub-entity is not non-tagged, then the entity manager 300 determines the entity is not non-tagged. In some such examples, if the sub-entities are a combination of tagged (e.g., fully and/or partially) and non-tagged, then the entity manager 300 determines the entity is partially-tagged. In an illustrated example, the example ratings manager 202 processes two sub-entities of an entity at a time. Although the illustrated example is disclosed in connection with the processing of two sub-entities (or entities), any number of entities may be processed. The two sub-entities may be at the bottom of a hierarchy (e.g., FIG. 1) and the example entity manger 300 may roll-up the hierarchy by processing sub-entities from the bottom to the top of the hierarchy.

The example metrics calculator 302 determines metrics for media campaigns of one or more entities and/or sub-entities. As used herein, metrics refer to audience measurements such as, for example, impressions, audience size, reach, frequency, unique audience, duration, etc. Based on the status of the sub-entities received from the example entity manager 300, the example metrics calculator 302 will use different data. For example, the metrics calculator 302 will use tagged data for fully-tagged and partially-tagged entities and the example metrics calculator 302 will use panelist data for partially-tagged and non-tagged entities. In some examples, the metrics calculator 302 determines metrics for a first data type separately from a second data type. For example, metrics for applications may be separated from metrics for text and/or video. In some examples, metrics for online media may be separated from metrics for mobile media. In some examples, the metrics calculator 302 utilizes audience measurements from tagged media such as, for example, media platform 222 (FIG. 2). For example, the metrics calculator 302 determines a reach a₁ for a first sub-entity SE1 based on the audience of the first sub-entity and a universe estimate UE (e.g., the population of an audience to be measured) according to Equation 1:

$${a}_{1} = \frac{SE 1 AUDIENCE}{UE} \qquad Equation 1$$

In the illustrated example, the first sub-entity SE1 is a tagged entity, and thus, the metrics calculator 302 determines the audience from tagged data. In some examples, the UE is 280,000. Alternatively, the UE may be the population of a country (e.g., the United States population).

In some examples, the metrics calculator 302 utilizes audience measurements from the example fusion panel database 212 (FIG. 2). For example, the metrics calculator 302 determines a reach a₂ for a second sub-entity SE2 based on the audience of the second sub-entity and the universe estimate according to Equation 2:

$${a}_{2} = \frac{SE 2 AUDIENCE}{UE} \qquad Equation 2$$

In the illustrated example, the second sub-entity SE1 is a non-tagged entity, and thus, the metrics calculator 302 determines the audience from panelist data (e.g., from the fusion panel database 212). In some examples, the metrics calculator 302 aggregates the metrics for each sub-entity to determine total metrics.

The example audience manager 304 determines a duplicated unique audience based on a duplication factor determined by the example de-duplicator 306 and the universe estimate according to Equation 3:

Duplicated Unique Audience(DUA)=DF·UE where: 0≤DUA≤min(panel audience,tag audience) Equation 3

The example audience manager 304 determines a de-duplicated unique audience based on a total unique audience between the first sub-entity and the second sub-entity and the duplicated unique audience. For example, the example audience manager 304 subtracts the duplicated unique audience from the total unique audience to determine the de-duplicated unique audience.

The example de-duplicator 306 determines panel duplication and a duplication factor between tagged (e.g., fully-tagged and/or partially-tagged) and non-tagged entities using metrics from entities and/or sub-entities determined by the example metrics calculator 302. As disclosed herein, an entity is only fully-tagged when all sub-entities are fully-tagged. As disclosed herein, an entity is only non-tagged when all sub-entities are non-tagged. As disclosed herein, an entity is partially-tagged when not all sub-entities are fully-tagged and when not all sub-entities are non-tagged. For example, one sub-entity may be non-tagged and one sub-entity may be partially-tagged, one sub-entity may be non-tagged and one sub-entity may be fully-tagged, one sub-entity may be partially-tagged and one sub-entity may be fully-tagged, multiple sub-entities are partially-tagged, etc. In some examples, a partially-tagged entity is treated like a non-tagged entity, as described above, if the entity does not include at least one fully-tagged sub-entity.

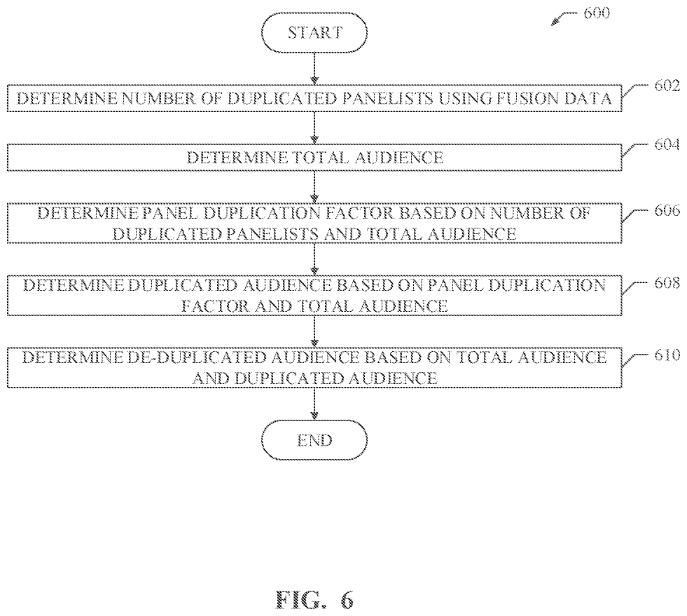

In examples wherein all entities/sub-entities are non-tagged, the de-duplicator 306 uses fusion panelist data (e.g., from the fusion panel database 212) to determine a panel duplication factor, as further described in connection with FIG. 6. In some such examples, the de-duplicator 306 determines the panel duplication factor to be the number of panelists that viewed multiple sub-entities (e.g., panel duplication) divided by the total number of panelists that viewed at least one sub-entity. The example audience manager 304 determines a de-duplicated panel audience DDPA according to Equation 4:

DDPA=TOTAL AUDIENCE−(PANEL DUPLICATION FACTOR*TOTAL AUDIENCE) Equation 4

In examples involving partially-tagged entities, the example de-duplicator 306 determines a duplication factor (DF) based on an odds ratio approach, as shown in Equation 5:

$$DF = \frac{\begin{matrix}[ ( {a}_{1} + {a}_{2} ) ( K - 1 ) + 1 \pm \\ \sqrt{[ {( ( {a}_{1} + {a}_{2} ) ( K - 1 ) + 1 )}^{2} - 4 ( K - 1 ) \cdot K \cdot {a}_{1} \cdot {a}_{2} ]} ]\end{matrix}}{2 ( K - 1 )} \\ where \text{:} 0 < DF < 1 \qquad Equation 5$$

To solve Equation 5, the example de-duplicator 306 utilizes the reach a₁ for the first sub-entity SE1 (e.g., Equation 1), the reach a₂ for the second sub-entity SE2 (e.g., Equation 2), and a duplication multiplier K. The example de-duplicator 306 determines the duplication multiplier K according to Equation 6:

$$K = \frac{( M * S )}{( F * D )} \qquad Equation 6$$

To solve Equation 6, the example de-duplicator 306 determines a plurality of variables M, S, F, and D. The example de-duplicator 306 determines a panel duplication reach M according to Equation 7:

$$M = \frac{( SE 1 SE 2 PANEL DUPLICATION )}{UE} \qquad Equation 7$$

The example de-duplicator 306 determines a de-duplicated panel reach F for the first sub-entity SE1 according to Equation 8:

$$\begin{matrix} Equation 8 \\ F = \frac{SE 1 PANEL AUDIENCE - SE 1 SE 2 PANEL DUP}{UE}\end{matrix}$$

For example, the de-duplicator 306 divides a de-duplicated panel audience for the first sub-entity (e.g., the panel audience of the first sub-entity minus the panel duplication) by the universe estimate.

The example de-duplicator 306 determines a de-duplicated panel reach D for the second sub-entity SE2 according to Equation 9:

$$\begin{matrix} Equation 9 \\ D = \frac{SE 2 PANEL AUDIENCE - SE 1 SE 2 PANEL DUP}{UE}\end{matrix}$$

For example, the de-duplicator 306 divides a de-duplicated panel audience the second sub-entity (e.g., the panel audience of the second sub-entity minus the panel duplication) by the universe estimate.

The example de-duplicator 306 determines the variable S according to Equation 10:

$$S = \frac{\begin{matrix}[ ( UE - SE 2 PANEL AUDIENCE ) - \\ ( SE 1 PANEL AUDIENCE - SE 1 SE 2 PANEL DUP ) ]\end{matrix}}{UE} \qquad Equation 10$$

In operation, the example entity manager 300 determines the status of a first sub-entity SE1 and a second sub-entity SE2. For example, the entity manager 300 determines that the first sub-entity SE1 is a tagged entity and the second sub-entity SE2 is a non-tagged entity. The example entity manager 300 communicates the status of the first sub-entity SE1 and the second sub-entity SE2 to the example metrics calculator 302. The example metrics calculator 302 determines metrics such as, for example, the reach for the first sub-entity SE1 (e.g., using tagged data) and the reach for the second sub-entity SE2 (e.g., using panelist data). The example de-duplicator 306 utilizes the reach for the first sub-entity SE1, the reach for the second sub-entity SE2, and the duplication multiplier determined to determine the duplication factor DF according to Equation 5. The example audience manager 304 determines the duplicated unique audience based on the duplication factor DF and the universe estimate according to Equation 3. The example audience manager 304 removes the duplicated unique audience from the total unique audience to determine the de-duplicated unique audience for an entity. The example ratings manager 202 repeats this operation by treating the entity of sub-entities SE1 and SE2 as a sub-entity in a subsequent iteration (e.g., roll-up). For example, the ratings manager 202 initially processes channels as entities and platforms as sub-entities. After all channels are processed, the ratings manager 202 processes sub-brands as entities and channels as sub-entities. Similarly, after all sub-brands are processed, the ratings manager 202 processes brands as entities and sub-brands as sub-entities.

While an example manner of implementing the example ratings manager 202 of FIG. 2 is illustrated in FIG. 3, one or more of the elements, processes and/or devices illustrated in FIG. 3 may be combined, divided, re-arranged, omitted, eliminated and/or implemented in any other way. Further, the example entity manager 300, the example metrics calculator 302, the example audience manager 304, the example de-duplicator 306 and/or, more generally, the example ratings manager 202 of FIG. 2 may be implemented by hardware, software, firmware and/or any combination of hardware, software and/or firmware. Thus, for example, any oft example entity manager 300, the example metrics calculator 302, the example audience manager 304, the example de-duplicator 306 and/or, more generally, the example ratings manager 202 of FIG. 2 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example entity manager 300, the example metrics calculator 302, the example audience manager 304, and/or the example de-duplicator 306 is/are hereby expressly defined to include a tangible computer readable storage device or storage disk such as a memory, a digital versatile disk (DVD), a compact disk (CD), a Blu-ray disk, etc. storing the software and/or firmware. Further still, the example ratings manager 202 of FIG. 2 may include one or more elements, processes and/or devices in addition to, or instead of, those illustrated in FIG. 3, and/or may include more than one of any or all of the illustrated elements, processes and devices.

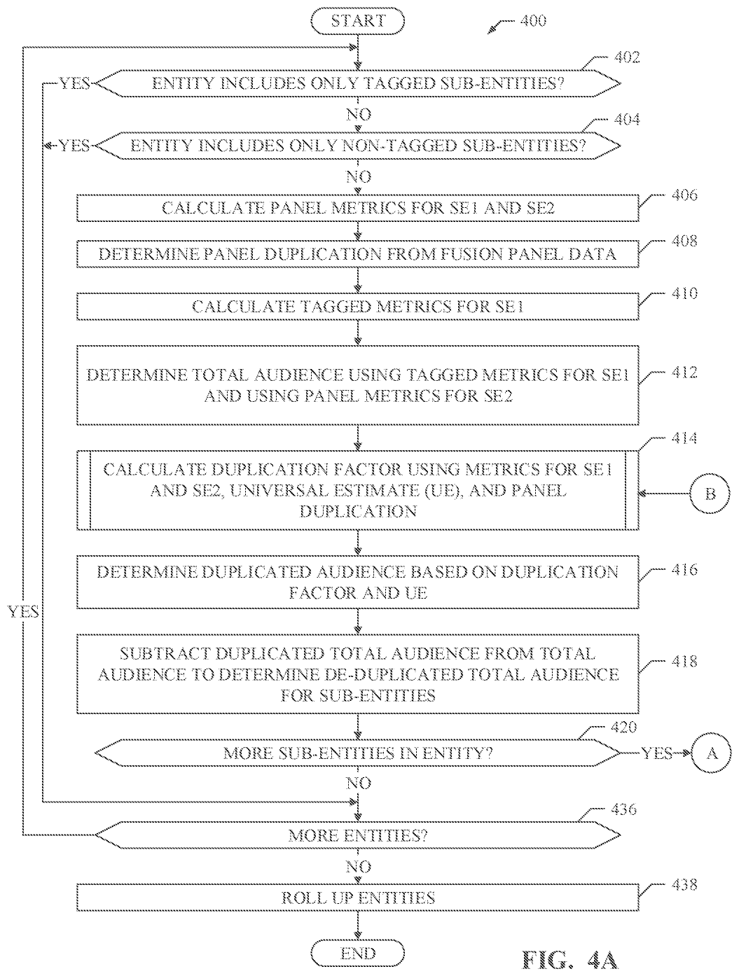

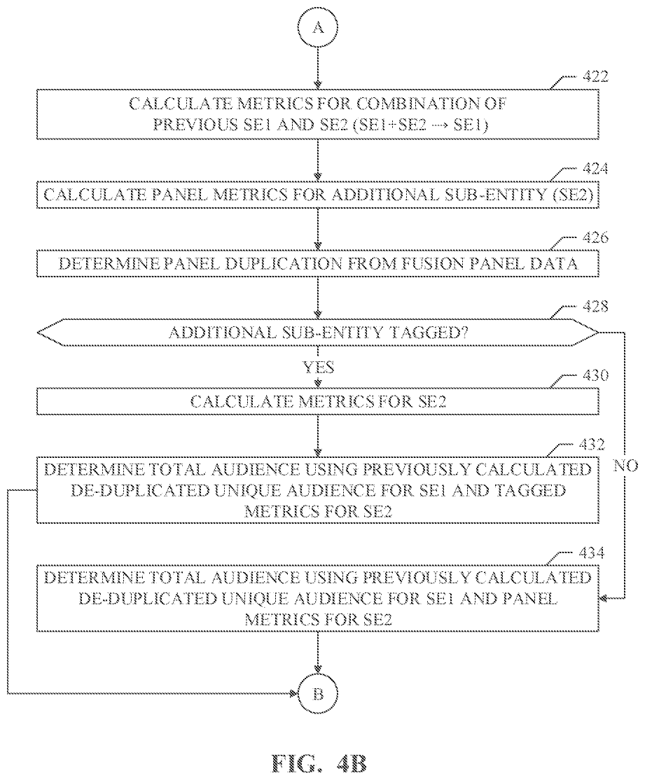

Flowcharts representative of example machine-readable instructions for implementing the example ratings manager 202 of FIG. 3 are shown in FIGS. 4A-6. In this example, the machine readable instructions comprise a program(s) for execution by a processor such as the processor 612 shown in the example processor platform 600 discussed below in connection with FIG. 6. The program(s) may be embodied in software stored on a tangible computer readable storage medium such as a CD-ROM, a floppy disk, a hard drive, a digital versatile disk (DVD), a Blu-ray disk, or a memory associated with the processor 612, but the entire program(s) and/or parts thereof could alternatively be executed by a device other than the processor 612 and/or embodied in firmware or dedicated hardware. Further, although the example program(s) is described with reference to the flowchart illustrated in FIGS. 4A-6, many other methods of implementing the example ratings manager 202 may alternatively be used. For example, the order of execution of the blocks may be changed, and/or some of the blocks described may be changed, eliminated, or combined.

As mentioned above, the example processes of FIGS. 4A-6 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and transmission media. As used herein, “tangible computer readable storage medium” and “tangible machine readable storage medium” are used interchangeably. Additionally or alternatively, the example processes of FIGS. 4A-6 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and transmission media. As used herein, when the phrase “at least” is used as the transition term in a preamble of a claim, it is open-ended in the same manner as the term “comprising” is open ended. Comprising and all other variants of “comprise” are expressly defined to be open-ended terms. Including and all other variants of “include” are also defined to be open-ended terms. In contrast, the term consisting and/or other forms of consist are defined to be close-ended terms.

FIGS. 4A-4B are flowcharts representative of example computer-readable instructions 400 to implement the ratings manager 202 of FIGS. 2-3 to process partially-tagged entities. The example computer-readable instructions 400 of FIGS. 4A-4B begin at block 402. At block 402, the example entity manager 300 determines whether an entity (e.g., a first channel) includes only fully-tagged sub-entities (e.g., media platforms). In some examples, entities with only fully-tagged sub-entities are fully-tagged entities and only use tagged data for audience measurement.

If the example entity manager 300 determines that the entity (e.g., the first channel) does not only include fully-tagged sub-entities (block 402: NO), control proceeds to block 404. At block 404, the example entity manager 300 determines whether the entity (e.g., the first channel) includes only non-tagged sub-entities. In some examples, a partially-tagged entity/sub-entity is treated as a non-tagged entity/sub-entity if the entity/sub-entity does not include at least one fully-tagged sub-entity. For example, partially-tagged platforms are treated as non-tagged entities (e.g., partially-tagged platforms do not include at least one fully-tagged entity). In some such examples, partially-tagged channels with no fully-tagged platforms are also treated as non-tagged entities. In some examples, entities with only non-tagged sub-entities are non-tagged entities and only use panelist data for audience measurement. If the example entity manager 300 determines that the entity (e.g., the first channel) does not only include non-tagged sub-entities (block 404: NO), control proceeds to block 406.

In the illustrated example, the entity (e.g., the first channel) is a partially-tagged entity including a tagged sub-entity SE1 and a non-tagged sub-entity SE2. At block 406, the example metrics calculator 302 calculates panel metrics for the example sub-entity SE1 and the example sub-entity SE2. For example, the metrics calculator 302 determines at least one of impressions, audience, reach, frequency, unique audience, and/or duration for each sub-entity based on panelist data. In the illustrated example, the panel audience for sub-entity SE1 is equal to 60, the panel unique audience for sub-entity SE2 is equal to 30, the panel reach for SE1 is equal to 60/280,000=0.00021486, and the panel reach for SE2 (e.g., a₂) is equal to 30/280,000=0.00010714. In some examples, the metrics calculator 302 receives panelist data from the fusion panel database 212 (FIG. 2) to determine the at least one of impressions, audience, reach, frequency, unique audience, and/or duration for each sub-entity. In some examples, the metrics calculator 302 aggregates the at least one of impressions, audience, reach, frequency, unique audience, and/or duration for each sub-entity for a total impression count, audience, reach, frequency, unique audience, and/or duration.

At block 408, the example de-duplicator 306 determines the panel duplication across the sub-entities (e.g., SE1 and SE2) from the fusion panel database 212 (e.g., 20). As disclosed herein, the panel duplication is the number of panelists who view all the sub-entities (e.g., both SE1 and SE2). At block, 410, the example metrics calculator 302 calculates tagged metrics for the example sub-entity SE1, because tagged data is available for SE1. For example, the metrics calculator 302 determines at least one of impressions, audience, reach, frequency, unique audience, and/or duration for the sub-entity SE1. In the illustrated example, the tagged unique audience for sub-entity SE1 is equal to 110, and the tag reach of sub-entity SE1 (e.g., a₁)=110/280,000=0.00039285.

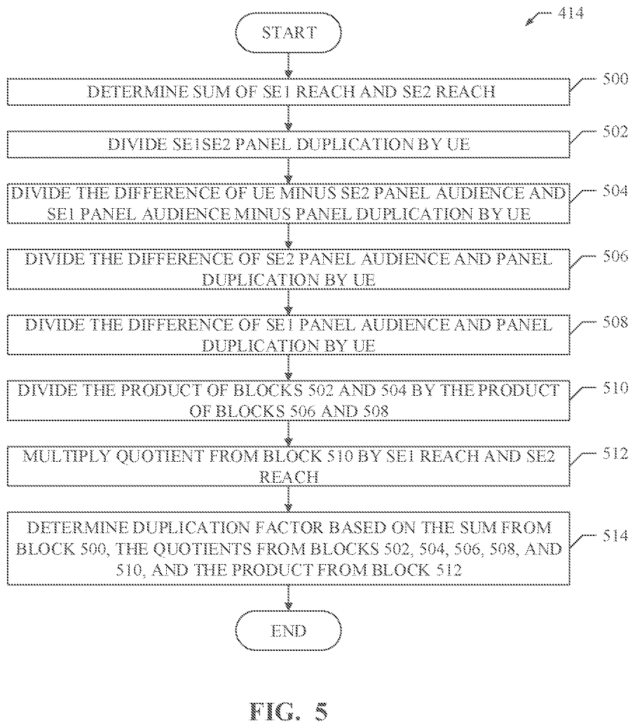

At block 412, the example audience manager 304 determines the total unique audience based on the tagged metrics for the example sub-entity SE1 (e.g., SE1 tagged unique audience=110) and the panel metrics for the example sub-entity SE2 (e.g., SE2 panel unique audience=30). For example, the example audience manager 304 adds the SE1 tagged unique audience (e.g., 110) to the SE2 panel unique audience (e.g., 30) to determine the total unique audience (e.g., 110+30=140). At block 414, the example de-duplicator 306 determines the duplication factor according to Equation 2 and Equations 4-10, and further described in connection with FIG. 5 (e.g., 0.000086868). At block 416, the example de-duplicator 306 determines the duplicated unique audience based on the duplication factor determined at block 414 (e.g., 0.000086868) and the universe estimate (e.g., 280,000) according to Equation 3. For example, the de-duplicator 306 multiplies the duplication factor (e.g., 0.000086868) by the universe estimate (e.g., 280,000) to determine the duplicated unique audience (e.g., 0.000086868*280,000=24.32304). In some examples, duplicated unique audience is rounded to the nearest whole number (e.g., 24). At block 418, the example audience manager 304 determines the de-duplicated unique audience for the sub-entities based on the duplicated unique audience determined at block 416 (e.g., 24) from the total unique audience determined at block 412 (e.g., 140). For example, the audience manager 304 subtracts the duplicated unique audience (e.g., 24) from the total unique audience (e.g., 140) to determine the de-duplicated unique audience for the sub-entities (e.g., 140−24=116).

At block 420, the example entity manager 300 determines whether there are more sub-entities (e.g., media platforms) under the entity (e.g., the first channel). If the example entity manager 300 determines that there are more sub-entities under the entity (block 420: YES), control proceeds to block 422. At block 422, the example metrics calculator 302 calculates metrics for the combination of the previous sub-entities (e.g., the first platform and the second platform). For example, the metrics calculator 302 calculates at least one of impressions, audience, reach, frequency, and/or duration for the combination of the first platform and the second platform (e.g., SE1+SE2). In some examples, the combination of the previous sub-entities is treated as a sub-entity for processing with an additional sub-entity (e.g., SE1+SE2→SE1). For example, combination of the previous sub-entities is treated as SE1 for the remainder of the computer-readable instructions 400. At block 424, the example metrics calculator 302 calculates panel metrics for an additional sub-entity (e.g., a third platform). For example, the metrics calculator 302 calculates at least one of impressions, audience, reach, frequency, unique audience, and/or duration for the additional sub-entity with panelist data. In some examples, the additional sub-entity is treated as SE2 for the remainder of the computer-readable instructions 400.

At block 426, the example de-duplicator 306 determines the panel duplication between the previously determined de-duplicated unique audience (e.g., the first platform and the second platform) and the additional sub-entity (e.g., the third platform). At block 428, the example entity manager 300 determines whether the additional sub-entity is tagged or non-tagged. If the additional sub-entity is tagged (block 428: YES), control proceeds to block 430. At block 430, the example metrics calculator 302 calculates tagged metrics for the additional sub-entity. For example, the metrics calculator 302 calculates at least one of impressions, audience, reach, frequency, unique audience, and/or duration for the additional sub-entity with tagged data. At block 432, the example audience manager 304 determines the total unique audience based on the previously determined de-duplicated unique audience and the tagged metrics for the example additional sub-entity SE2 (e.g., SE2 tag unique audience). Thereafter, control returns to block 414.

If the additional sub-entity is non-tagged (block 428: NO), control proceeds to block 434. At block 434, the example audience manager 304 determines the total unique audience based on the previously determined de-duplicated unique audience and the panel metrics for the example additional sub-entity SE2 (e.g., SE2 panel unique audience). Thereafter, control returns to block 414.

If the example entity manager 300 determines that there are no more sub-entities under the entity (block 420: NO), if the example entity manager 300 determines that the entity only includes fully-tagged sub-entities (block 402: YES), or if the example entity manager 300 determines that the entity only includes non-tagged sub-entities (block 404: YES), control proceeds to block 436. In some examples, if the example entity manager 300 determines that the entity only includes non-tagged sub-entities (block 404: YES), the entity is processed as discussed in connection with FIG. 6.

At block 436, the example entity manager 300 determines whether there are more entities. For example, once the first channel has been processed, other channels under a sub-brand may need to be processed. Therefore, if the example entity manager 300 determines that there are more entities (block 436: YES), control returns to block 402 to process another entity. If the example entity manager 300 determines that there are no more entities (block 436: NO), control proceeds to block 438.

At block 438, the example entity manager 300 rolls up the entities. For example, the example instructions 400 are first executed with channels as entities and platforms as sub-entities. After all channels are processed, the example instructions 400 are re-executed with sub-brands as entities and channels as sub-entities. Similarly, after all sub-brands are processed, the example instructions 400 are re-executed with brands as entities and sub-brands as sub-entities. Once all entities for a media campaign have been processed, the example instructions 400 cease operation.

FIG. 5 is a flowchart representative of an example implementation of block 414 to determine the duplication factor. The example implementation of block 414 begins at block 500. At block 500, the example de-duplicator 306 determines the sum of the reach of the first sub-entity (e.g., a₁=110/280,000=0.00039285) and the reach of the second sub-entity (e.g., a₂=30/280,000=0.00010714). In the illustrated example, a₁+a₂=0.00039285+0.00010714=0.0005. In some examples, the de-duplicator 306 receives the reach of the first sub-entity and the reach of the second sub-entity from the metrics calculator 302.

At block 502, the example de-duplicator 306 divides the panel duplication determined at block 408 (e.g. 20) by the universe estimate (e.g., 280,000) to determine a panel duplication reach M according to Equation 7. In the illustrated example, M=20/280,000=0.000071429.

At block 504, the example de-duplicator divides the difference of the universe estimate minus the panel audience for the second sub-entity and the panel audience of the first sub-entity minus the panel duplication determined at block 408 by the universe estimate. As disclosed herein, the de-duplicator 306 stores this quotient as the variable S according to Equation 9. For example, the de-duplicator 306 subtracts the panel audience for the second sub-entity (e.g., 30) from the universe estimate (e.g., 280,000) to determine a non-panel universe (e.g., 279,970). The example de-duplicator 306 subtracts the panel duplication (e.g., 20) from the panel audience for the first sub-entity (e.g., 60) to determine a de-duplicated panel audience for the first sub-entity (e.g., 40). The example de-duplicator 306 divides the difference between the non-panel universe (e.g., 279,970) and the de-duplicated panel audience for the first sub-entity (40) by the universe estimate (e.g., 280,000). In the illustrated example, S=(279,070−40)/280,000=0.99975.

At block 506, the example de-duplicator 306 divides the difference between the panel audience for the second sub-entity (e.g., 30) and the panel duplication (e.g., 20) by the universe estimate (e.g., 280,000). As disclosed herein, the de-duplicator 306 stores this quotient as the variable D according to Equation 10. In the illustrated example, D=(30−20)/280,000=0.000035714.

At block 508, the example de-duplicator 306 divides the difference between the panel audience for the first sub-entity (e.g., 60) and the panel duplication (e.g., 20) by the universe estimate (e.g., 280,000). As disclosed herein, the de-duplicator 306 stores this quotient as the variable F according to Equation 8. In the illustrated example, F=(60−20)/280,000=0.000142857.

At block 510, the example de-duplicator 306 divides the product of the quotient of block 502 (e.g., M=0.000071429) and the quotient of block 504 (e.g., S=0.99975) by the product of the quotient of block 506 (e.g., D=0.000035714) and the quotient of block 508 (e.g., F=0.000142857) to determine a duplication multiplier (e.g., Equation 6). As disclosed above, the non-panel universe and the de-duplicated panel audience for the first sub-entity are determined at block 504 and the de-duplicated panel audience for the second sub-entity is determined at block 506. Accordingly, the duplication multiplier is based on at least the non-panel universe, the de-duplicated panel audience for the first sub-entity, and the de-duplicated panel audience for the second sub-entity. In the illustrated example, K=(0.000071429*0.99975)/(0.000035714*0.000142857)=13996.5.

The example de-duplicator 306 multiplies the quotient from block 510 (e.g., the duplication multiplier K) by the reach of the first sub-entity (e.g., a₁=110/280,000=0.00039285) and the reach of the second sub-entity (e.g., a₂=30/280,000=0.00010714) (block 512). As disclosed above, the reach of the first sub-entity is based on the tagged audience (e.g., 110) and the universe estimate (e.g., 280,000), and the reach of the second sub-entity is based on the panel audience (e.g., 30) and the universe estimate (e.g., 280,000). In the illustrated example, Ka₁a₂=13996.5*0.00039285*0.00010714=0.00589138.

As disclosed herein, the example de-duplicator 306 solves Equation 5 to determine the duplication factor. At block 514, the example de-duplicator 306 determines a duplication factor DF based on the sum from block 500, the quotients from blocks 502, 504, 506, 508 and 510, and the product from block 512. In the illustrated example,

$$DF = \frac{\begin{matrix}( 0.0005 ) ( 13996.5 - 1 ) + 1 \pm \\ \sqrt{[ {( ( 0.0005 ) ( 13996.5 - 1 ) + 1 )}^{2} - 4 ( 13996.5 - 1 ) \cdot 0.00589138 ]}\end{matrix}}{2 ( 13996.5 - 1 )} = 0.000086868 .$$

As disclosed herein, the duplication factor DF is used in block 416 of FIG. 4. Thus, the example de-duplicator 306 sends the duplication factor DF to the example audience manager 304. Thereafter, the example implementation of block 414 ceases operation.

FIG. 6 is a flowchart representative of example computer-readable instructions 600 to implement the de-duplicator 306 to process non-tagged entities. The example computer-readable instructions 600 begin at block 602. At block 602, the example de-duplicator 306 determines a number of duplicated panelists using fusion data. For example, between two entities or sub-entities, the de-duplicator 306 determines the number of panelists that viewed both entities or sub-entities based on panelist data from a fusion panel (e.g., mobile and online fusion panel). The example de-duplicator 306 determines the total unique audience or the total number of panelists that viewed either entities or sub-entities (e.g., including the panelists that viewed both) (block 604).

The example de-duplicator 306 determines a panel duplication factor based on the number of duplicated panelists and the total unique audience (block 606). For example, the panel duplication factor may be a ratio of the number of duplicated panelists and the total unique audience. At block 608, the example de-duplicator 306 determines a duplicated unique audience based on the panel duplication factor and the total unique audience. The example de-duplicator 306 determines a de-duplicated unique audience based on the total unique audience and the duplicated unique audience (block 610). For example, the de-duplicator 306 removes the duplicated unique audience from the total unique audience to determine the de-duplicated unique audience. Thereafter, the example computer-readable instructions 600 cease operation.

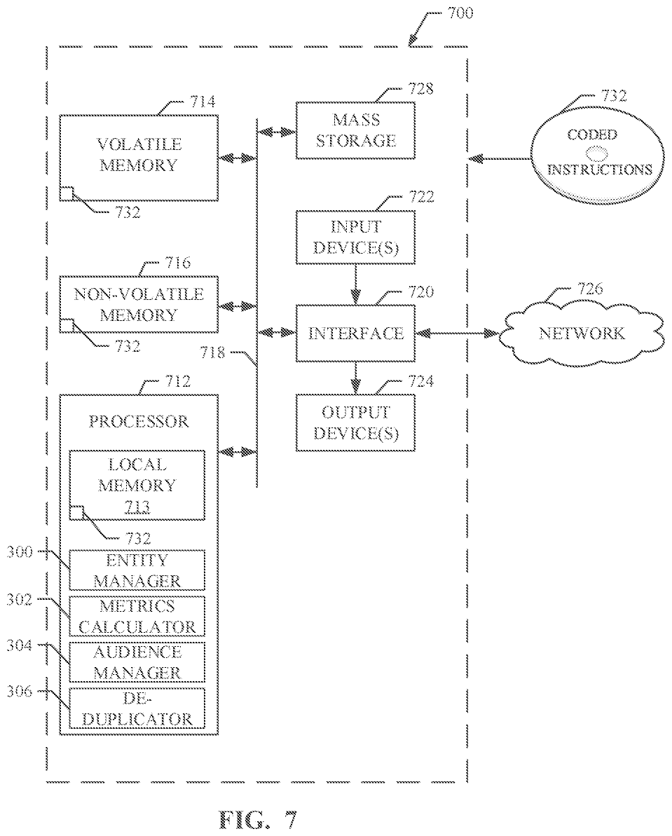

FIG. 7 is a block diagram of an example processor platform 700 capable of executing the instructions of FIGS. 4A-6 to implement the ratings manager 202 of FIGS. 2 and/or 3. The processor platform 700 can be, for example, a server, a personal computer, a mobile device (e.g., a cell phone, a smart phone, a tablet such as an iPad′), a personal digital assistant (PDA), an Internet appliance, a DVD player, a CD player, a digital video recorder, a Blu-ray player, a gaming console, a personal video recorder, a set top box, or any other type of computing device.

The processor platform 700 of the illustrated example includes a processor 712. The processor 712 of the illustrated example is hardware. For example, the processor 712 can be implemented by one or more integrated circuits, logic circuits, microprocessors or controllers from any desired family or manufacturer.

The processor 712 of the illustrated example includes a local memory 713 (e.g., a cache). The processor 712 of the illustrated example is in communication with a main memory including a volatile memory 714 and a non-volatile memory 716 via a bus 718. The volatile memory 714 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 716 may be implemented by flash memory and/or any other desired type of memory device. Access to the main memory 714, 716 is controlled by a memory controller.

The processor platform 700 of the illustrated example also includes an interface circuit 720. The interface circuit 720 may be implemented by any type of interface standard, such as an Ethernet interface, a universal serial bus (USB), and/or a PCI express interface.

In the illustrated example, one or more input devices 722 are connected to the interface circuit 720. The input device(s) 722 permit(s) a user to enter data and commands into the processor 712. The input device(s) 722 can be implemented by, for example, an audio sensor, a microphone, a camera (still or video), a keyboard, a button, a mouse, a touchscreen, a track-pad, a trackball, isopoint and/or a voice recognition system.

One or more output devices 724 are also connected to the interface circuit 720 of the illustrated example. The output devices 624 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 720 of the illustrated example, thus, typically includes a graphics driver card, a graphics driver chip or a graphics driver processor.

The interface circuit 720 of the illustrated example also includes a communication device such as a transmitter, a receiver, a transceiver, a modem and/or network interface card to facilitate exchange of data with external machines (e.g., computing devices of any kind) via a network 726 (e.g., an Ethernet connection, a digital subscriber line (DSL), a telephone line, coaxial cable, a cellular telephone system, etc.).

The processor platform 700 of the illustrated example also includes one or more mass storage devices 728 for storing software and/or data. Examples of such mass storage devices 728 include floppy disk drives, hard drive disks, compact disk drives, Blu-ray disk drives, RAID systems, and digital versatile disk (DVD) drives.

The coded instructions 732 of FIGS. 4A-6 may be stored in the mass storage device 728, in the volatile memory 714, in the non-volatile memory 716, and/or on a removable tangible computer readable storage medium such as a CD or DVD.

From the foregoing, it will be appreciated that the above-disclosed methods, apparatus and articles of manufacture de-duplicate partially-tagged entities. For example, the above-disclosed methods, apparatus and articles of manufacture determine numerous metrics for tagged and non-tagged sub-entities that make up partially-tagged entities. The above-disclosed methods, apparatus and articles of manufacture de-duplicate unique audiences of the tagged, partially-tagged, and/or non-tagged sub-entities and entities to report accurate audience measurements.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method to de-duplicate a partially-tagged entity, the method comprising:
accessing, by executing an instruction with a processor, an access monitor to determine whether a first sub-entity or a second sub-entity of a partially-tagged entity is fully-tagged, the partially-tagged entity including a collection of media, the first sub-entity including digital media having media tags embedded in the digital media, the second sub-entity including untagged media, the digital media of the first sub-entity being a first data type and the untagged media of the second sub-entity being a second data type;
identifying, by executing an instruction with the processor, a tagged audience for the first sub-entity, the tagged audience including a number of audience members identified based on detection of the media tags embedded in the digital media included in the first sub-entity;
identifying, by executing an instruction with the processor, a panel audience for the second sub-entity;
estimating, by executing an instruction with the processor, a duplicated audience based on the tagged audience and the panel audience, the duplicated audience representing a set of panelists estimated to have accessed both the first sub-entity of the first data type and the second sub-entity of the second data type;
determining, by executing an instruction with the processor, a de-duplicated audience for the partially-tagged entity based on the duplicated audience and a total audience, the total audience including the tagged audience for the first sub-entity of the first data type and the panel audience for the second sub-entity of the second data type; and
reporting, by executing an instruction with the processor, a digital audience measurement including a reach of the partially-tagged entity, the reach based on the de-duplicated audience.

2. The method of claim 1, wherein the panel audience includes panelists registered on a panel maintained by a media monitoring entity.

3. The method of claim 1, wherein the first data type corresponds to video and the second data type corresponds to text.

4. The method of claim 1, further including storing the identified tagged audience for the first sub-entity of the first data type and the identified panel audience for the second sub-entity of the second data type.

5. The method of claim 4, further including determining a panel duplication value based on the stored tagged audience and the stored panel audience, the panel duplication value representing a second number of audience members who accessed both the first sub-entity and the second sub-entity.

6. The method of claim 1, further including determining (1) a first reach of the first sub-entity based on the tagged audience and a universe estimate, and (2) a second reach of the second sub-entity based on the panel audience and the universe estimate.

7. The method of claim 1, further including determining at least one of impressions, audience, frequency, unique audience, or duration for the first sub-entity based on tagged data.

8. An apparatus to de-duplicate a partially-tagged entity, the apparatus comprising:
an entity manager to detect an access monitor to determine whether a first sub-entity or a second sub-entity is fully-tagged, the partially-tagged entity including a collection of media, the first sub-entity including digital media having media tags embedded in the digital media, the second sub-entity including untagged media, the digital media of the first sub-entity being a first data type and the untagged media of the second sub-entity being a second data type; and
an audience manager to:
identify a tagged audience for the first sub-entity, the tagged audience including a number of audience members identified based on detection of the media tags embedded in the digital media included in the first sub-entity;
identify a panel audience for the second sub-entity;
estimate a duplicated audience based on the tagged audience and the panel audience, the duplicated audience representing a set of panelists estimated to have accessed both the first sub-entity of the first data type and the second sub-entity of the second data type;
determine a de-duplicated audience for the partially-tagged entity based on the duplicated audience and a total audience, the total audience including the tagged audience for the first sub-entity of the first data type and the panel audience for the second sub-entity of the second data type; and
report a digital audience measurement including a reach of the partially-tagged entity, the reach based on the de-duplicated audience.

9. The apparatus of claim 8, wherein the panel audience includes panelists registered on a panel maintained by a media monitoring entity.

10. The apparatus of claim 8, wherein the first data type corresponds to video and the second data type corresponds to text.

11. The apparatus of claim 8, further including a database to store the identified tagged audience for the first sub-entity of the first data type and the identified panel audience for the second sub-entity of the second data type.

12. The apparatus as defined in claim 11, wherein the audience manager is to determine a panel duplication value based on the stored tagged audience and the stored panel audience, the panel duplication value representing a second number of audience members who accessed both the first sub-entity and the second sub-entity.

13. The apparatus of claim 8, wherein the audience manager is to determine (1) a first reach of the first sub-entity based on the tagged audience and a universe estimate, and (2) a second reach of the second sub-entity based on the panel audience and the universe estimate.

14. The apparatus of claim 8, wherein the audience manager is to determine at least one of impressions, audience, frequency, unique audience, or duration for the first sub-entity based on tagged data.

15. A non-transitory computer readable medium comprising instructions that, when executed, cause a machine to at least:
detect an access monitor to determine whether a first sub-entity or a second sub-entity is fully-tagged, the partially-tagged entity including a collection of media, the first sub-entity including digital media having media tags embedded in the digital media, the second sub-entity including untagged media, the digital media of the first sub-entity being a first data type and the untagged media of the second sub-entity being a second data type;
identify a tagged audience for the first sub-entity, the tagged audience including a number of audience members identified based on detection of the media tags embedded in the digital media included in the first sub-entity;
identify a panel audience for the second sub-entity;
estimate a duplicated audience based on the tagged audience and the panel audience, the duplicated audience representing a set of panelists estimated to have accessed both the first sub-entity of the first data type and the second sub-entity of the second data type;
determine a de-duplicated audience for the partially-tagged entity based on the duplicated audience and a total audience, the total audience including the tagged audience for the first sub-entity of the first data type and the panel audience for the second sub-entity of the second data type; and
report a digital audience measurement including a reach of the partially-tagged entity, the reach based on the de-duplicated audience.

16. The non-transitory computer readable medium as defined in claim 15, wherein the panel audience includes panelists registered on a panel maintained by a media monitoring entity.

17. The non-transitory computer readable medium as defined in claim 15, wherein the first data type corresponds to video and the second data type corresponds to text.

18. The non-transitory computer readable medium as defined in claim 15, wherein the instructions, when executed, cause the machine to store the identified tagged audience for the first sub-entity of the first data type and the identified panel audience for the second sub-entity of the second data type.

19. The non-transitory computer readable medium as defined in claim 18, wherein the instructions, when executed, cause the machine to determine a panel duplication value based on the stored tagged audience and the stored panel audience, the panel duplication value representing a second number of audience members who accessed both the first sub-entity and the second sub-entity.

20. The non-transitory computer readable medium as defined in claim 15, wherein the instructions, when executed, cause the machine to determine (1) a first reach of the first sub-entity based on the tagged audience and a universe estimate, and (2) a second reach of the second sub-entity based on the panel audience and the universe estimate.
